(19) United States
(12) Patent Application Publication
(10) Pub. No.: US 2011/0126617 A1
(43) Pub. Date: Jun. 2, 2011

(54) LASER SENSOR BASED SYSTEM FOR STATUS DETECTION OF TIRES

(75) Inventors: Jaione Bengoechea Apezteguia, Aachen (DE); Holger Moench, Vaals (NL)

(73) Assignee: KONINKLIJKE PHILIPS ELECTRONICS N.V., EINDHOVEN (NL)

(21) Appl. No.: 12/674,915

(22) PCT Filed: Aug. 29, 2008
(86) PCT No.: PCT/IB08/53501

§ 371 Date: Feb. 24, 2010

(30) Foreign Application Priority Data
Sep. 3, 2007 (EP) 07115533.7

(51) Int. Cl. G01M 17/02

(52) U.S. Cl. 73/146

(57) ABSTRACT

A system is described which enables parameters of a tire (20) to be measured by means of self-mixing laser interferometry. Laser sensors (1) using self-mixing laser interferometry can measure distances and/or speed of surface elements of a tire (20). Consequently, a system comprising such a laser sensor (1) can for example be used to measure and indicate tire tread wear, tire load or speed. In comparison with laser sensor based systems using the well-known time of flight method, the described system is simple, cost effective and, due to the small size of the laser sensor (1), can easily be integrated in cars.

### FIELD OF THE INVENTION

The current invention is related to a laser sensor based system for measuring tire parameters, the use of such a laser sensor based system for measuring tire tread wear, tire load, or vehicle speed, and a laser based method of measuring tire parameters.

### BACKGROUND OF THE INVENTION

In EP 0547365 B1, a method and apparatus for measuring tire parameters is disclosed. The tread wear of a tire can be circumferentially measured by means of the described apparatus. A laser probe sequentially scans each of the ribs of a tire, obtaining data regarding the tread depth at various points along the ribs. This data is employed for each rib to determine heel-to-toe irregular wear of the lugs thereof and also to determine a total wear index indicative of the degree of wear of the lugs. The method and apparatus are also adapted to laterally scan the tire sidewall to obtain data for ascertaining any anomalies thereof. The movement of the tire has to be defined and tightly controlled with respect to the laser probe in order to get reliable measurement results.

### SUMMARY OF THE INVENTION

It is an objective of the current invention to provide a simple and cost effective system for measuring tire parameters.

The objective is achieved by means of a system for measuring tire parameters, comprising at least one laser sensor, an analyzer and an indicator, the laser sensor being designed to emit laser light and detect the laser light thrown back by a tire by means of self-mixing laser interferometry, the analyzer being designed to process sensor data provided by the laser sensor and the indicator being designed to indicate the status of the tire.

Laser sensors based on self-mixing interferometry (SMI) make use of the effect that laser light, which is thrown back from the surface of the tire and reenters the laser cavity, interferes with the resonating radiation and thus influences the output properties of the laser. The laser light being thrown back comprises scattered, diffusely reflected and/or specularly reflected laser light. Semiconductor lasers are frequently used as laser light sources in SMI laser sensors. If these lasers are operated with a defined current shape, for example a periodic saw tooth or triangular current, the output frequency of the laser almost instantaneously follows those current variations due to the simultaneously changed optical resonator length. A photo detector measures the resulting difference in frequency between the resonating and the back-scattered light. The signal measured by the photo detector can be evaluated in an analyzer and can be translated back to the desired position or velocity information. When the laser is operated not too far above the laser threshold, the response to the back-coupled light is linear, and the resulting variations in output power or frequency contain traceable information on the movement or the distance of the surface of the tire with respect to the sensor. Even if the laser is operated far above the laser threshold, resulting in a non-linear response to the back-coupled light, the resulting variations in output power or frequency contain traceable information on the movement or the distance of the surface of the tire with respect to the sensor as long as the non-linearity is known. This traceable information related to the distance between the surface of the tire and a reference point, the surface structure of the tire and the movement of the tire, is regarded as tire parameters. The laser output signal, which contains the information, is for example collected via a photo detector being comprised in the laser sensor. Physically the photo detector can either be an integrated part of the laser sensor together with the laser diode or alternatively the photo detector may be a part of the analyzer and the photo diode may be mounted on top. In contrast to the well known time of flight measurements described in the prior art, systems for measuring tire parameters comprising a laser sensor based on self-mixing interferometry enable a multitude of applications without costly timing between the movement of the tire and the laser sensor and costly evaluation of the measurements. The laser diode may be, amongst others, a vertical cavity surface emitting laser (VCSEL) or a side emitter. The surface structure can be, for example, the tread of a tire measured in a stationary testing device as depicted in FIG. 1 of EP 0547365 B1 or the system can be integrated in a vehicle like a car. The tread of the tire throws back the laser light at the maximum distance between the laser diode and the tire surface (bottom of the grooves in the tire) and the minimum distance between the laser diode and the tire surface. In the laser cavity the different distances are translated into two different beat frequencies due to the path differences between the emitted signal and the reflected signals. The difference in beat frequency is a measure of the depth of the grooves, wherein the average of both frequencies is a measure of the total distance between the laser diode and the tire. The total distance between the laser diode and the tire may be used to determine the load of a tire. As the average changes only slowly, it could be an advantage to measure only the difference between the two tread frequencies and the average. This may help to reduce the required signal processing effort. Especially, it can be helpful to mix down using the expected (from the last few measurements) average frequency (distance sensor-wheel). This allows working with much lower frequencies in the digital part of an analyzer, thereby reducing costs. The bandwidth is then limited to the difference between the two frequencies. Using only one laser sensor, the movement of the laser sensor itself or the provision of an optical element being able to deflect the emitted laser beam, such as a moveable mirror, can be used to scan the surface of the tire in order to get a complete picture of the surface structure of the tire. In alternative or additional applications, the speed of surface elements of the tire can be detected with the same SMI laser sensor, enabling an indirect speed measurement of a vehicle if the laser sensor is integrated in the vehicle. Further vibrations of the tire can be detected by measuring the oscillating movement of the tire. The vibrations might be induced by unbalance of the tire or by irregularities of a surface where the tire is rolling on. The vibrations would for example cause the two beat frequencies caused by the tire tread to oscillate. The analyzer and the indicator enable the representation of tire parameters such as for example surface structure or speed to a user such as for example a driver of a car. Measurement and representation of tire parameters can be continuous or non-continuous, wherein the indicator can be any kind of interface for providing the measurement data analyzed by the analyzer to an end user or a further device for further processing of the data. In general, the analyzer and the indicator may be separate devices or one integrated device. Further, the analyzer and the indicator may be realized by means of software programs integrated in other systems. Optionally, the system for measuring tire parameters can be used to measure different tire parameters such as surface structure, speed of surface elements of the tire, vibrations of surface elements of the tire and/or distance between the laser sensor and the tire sequentially, using only one laser sensor.

The laser sensor may comprise an optical device for beam shaping of the emitted laser light. The optical device may be a lens either focusing the laser light to the surface of the tire or collimating the laser light into a parallel beam. Focusing the laser light on the surface of the tire increases the resolution of the laser sensor, while a parallel beam of laser light needs no refocusing and may prevent problems related to a fixed focus distance since auto-focussing to focus the surface of the tire independently of the distance may be possible, but seems to be rather costly and probably prone to error. The parallel beam may enable the simultaneous measurement of the two beat frequencies caused by the laser light thrown back at the bottom of the grooves and the upswings in between because of the enlarged spot diameter. Additionally, area-wide scanning of the surface of the tire may be possible by using an array of laser sensors each having an enlarged spot diameter of for example 1 cm.

In a further embodiment according to the current invention, the laser sensor comprises a vertical cavity surface-emitting laser.

Vertical cavity surface-emitting lasers are well suited for SMI-based laser sensors. Infrared vertical cavity surface-emitting lasers (VCSEL) are quite common in optical communication applications. The laser cavity consists of two stacks of Distributed Bragg Reflectors (DBRs), which are epitaxially grown on a suited substrate, and which enclose a gain region made up of several quantum wells. The DBR layers also take over the task of feeding current into the gain region. Therefore one of the DBRs is usually n-doped and the other p-doped. In such a VCSEL one of the DBRs is designed to be highly reflective, typically the p-DBR with a reflectivity of >99.9% for the lasing wavelengths, while the other one allows efficient out-coupling of the laser radiation and thus also feedback from the target object such as the surface of a tire into the laser cavity. The big advantage of VCSELs is that due to their surface emitting properties they can be produced and tested on wafer level in large quantities, which opens the possibility of a low-cost production process. Furthermore, the output power can, to a certain extent, be scaled via the area of the emitting surface. Larger output powers can be achieved by using VCSEL arrays. Surprisingly, it has been found that VCSEL-based SMI laser sensors without external cavity can be used for detecting the distance to or the movement of objects being spaced apart more than some millimeters despite the short cavity length. The short cavity length was believed to determine the coherence length of the emitted laser beam causing the restrictions in the detection range. The enhanced detection range enables the detection of the distance to the surface of the tire, which can be used for the determination of the surface structure of the tire. A special embodiment of a VCSEL is a vertical external cavity surface-emission laser (VECSEL). In a VECSEL the reflectivity of the outcoupling DBR is decreased, thus reducing the feedback of the outcoupling DBR below the laser threshold. An additional external reflector such as e.g. a DBR is used to provide additional feedback in order to enable lasing. The external reflector forms an external cavity in relation to the gain medium, enhancing the cavity length and thus the coherence length of the laser, resulting in an enhanced detection range of the SMI laser sensor, thus further improving the reliability of the system. The VCSEL and VECSEL enable the integration of the photo detector sensing the feedback signal of the tire. The photo detector can be attached to the highly reflective DBR, in which case the reflectivity of the highly reflective mirror is preferably reduced to <99.9% in comparison to a pure laser source in order to enable the transmission of a stronger signal to the photo detector.

In one embodiment according to the current invention, the system is integrated in a vehicle.

The vehicle might be for example a car, a truck or a motorbike. The integration of the system, for example, in a car can enable the detection of tread wear of tires during driving. Beside tread wear, irregularities of the surface of the tires caused for example by nails can be detected. Further, the detection of unbalance by detecting vibrations may be possible, thus preventing early wear of tires. Alternatively or in addition, the load of a car and the tire can be detected by measuring the distance between the chassis and the tire. By measuring the speed of the surface of at least one of the tires the speed of the car can be indirectly measured.

In another embodiment according to the current invention, the system further comprises a storing device for storing reference data, the analyzer is designed to compare the sensor data provided by the self-mixing laser sensor with the reference data, and the indicator is designed to indicate the result of the comparison between the reference data and the sensor data.

The reference data can be for example tire tread data of a new tire without tread wear. This data might be specific to the tire in question and can be chosen either automatically by comparing the results of a calibration measurement with data sets in the storing device or manually by means of the user of the system, in dependence on the specific tire of which parameters are measured. The storing device may enable updates of the stored data by means of an interface. Irregularities or damage caused by foreign objects or kerbing damage can be detected by comparing the measurements with the reference data. The reference data may also comprise a reference distance between the sensor and the surface of the tire. By means of this reference distance the static load of a vehicle like a car or a truck where tires are coupled, can be detected by measuring the distance to the tire surface preferably at rest. Further, the distance measurement can be used for detection of dynamic load of a car during, for example, taking a bend as described above, where the result of the measurement may be used to determine and prevent dangerous driving by warning a driver via the indicator. Optionally, the distance measurements can be corrected for the tread wear of the tire that may be determined by the same laser sensor, wherein the data related to the tread wear may be measured once, for example at the beginning of a trip, and stored in a non-permanent memory of the storing device. Further, the tread and the tread wear can be measured either continuously or at least periodically, and the measured data may be stored in the storing device for a predetermined period of time. This history of the tread wear stored in the storing device may be used to prevent misleading measurements due to mud or snow in the grooves of the tires by comparing the actual measurements with the historical data (tread wear doesn't happen within minutes or hours). Alternatively or additionally, control measurements detecting the absolute distance between tire and laser sensor and related historical data may be used to prevent false alarms of the system. If for example the average distance between the tire and the laser sensor decreases during driving, there is a strong indication that the grooves of the tread are filled with material (mud or snow); conversely tread wear would cause an increasing average distance between the tire and the laser sensor.

In a further embodiment according to the current invention, the system comprises at least one laser sensor per tire of the vehicle.

Using at least one laser sensor per tire of the vehicle enables the detection of tire parameters of all tires, enabling the comparison of the measurement data of one tire with the measurement data of another tire.

In still another embodiment according to the current invention, the system comprises a multitude of laser sensors for measuring tire parameters of one tire of the vehicle.

Using for example two laser sensors for one tire makes it possible to measure the distance to the tire and the velocity of surface elements of the tire at the same time. A linear array of three or more laser sensors can be used to scan the whole surface of a tire without moving either the laser sensor or an associated optical element such as, for example, a mirror. Providing a multitude of laser sensors for each tire enables comparison of the measurement data of one tire from different positions, as well as comparison with the measurement data of another tire.

In a further embodiment according to the current invention, the analyzer is further designed to compare the sensor data of the different tires of the vehicle and the indicator is further designed to indicate the result of the comparison of the sensor data of the different tires of the vehicle.

Using one laser sensor per tire or a multitude of laser sensors per tire or a combination of both enables the detection of unbalance of the tires affecting the stability of the car. Lopsided tire tread wear, for example, can easily be detected by means of an array of laser sensors per tire sensing the surface of the corresponding tire and can be indicated to the user. After detection of lopsided tire tread wear and comparison of the measured data with reference data stored in a storage device, the data processed by the analyzer and indicated by the indicator may provide additional information to the user such as for example a defined permutation of the tires in order to guarantee regular tire tread wear. Additionally, the system can be used to detect resonances of the vehicle causing undesirable noise and losses by detecting oscillations of the tire relative to the chassis of the vehicle where the laser sensor is mounted. In the latter case, the system may be coupled to a further control system for adaptive damping for example by actively tuning the damping of all shock absorbers collectively or of each shock absorber individually. The indicator would be used as interface to the control system. Alternatively, the analyzer and the indicator may be integrated in the control system (e.g. software running on a processor of the control system). The tuning of the shock absorbers may dampen and/or detune the resonances. In another application, sliding of the vehicle can be detected by comparing the velocity of surface elements of a first tire with the velocity of surface elements of at least one different tire. The results of the comparison of the velocity of surface elements of different tires can be used to warn the user of the vehicle. Alternatively or in addition, the results of the comparison of the velocity of surface elements of different tires can be used as input data for automatic control and security systems preventing dangerous situations caused by sliding.

The tire or the tires may comprise one or more reflective structures for improving the measuring of tire parameters by means of a system for measuring tire parameters comprising at least one laser sensor, an analyzer and an indicator, the laser sensor being designed to emit laser light and detect the laser light thrown back by a tire by means of self-mixing laser interferometry, the analyzer being designed to process sensor data provided by the laser sensor and the indicator being designed to indicate the status of the tire. The laser light emitted by the laser sensor and subsequently thrown back by the tire may be insufficient to provide a signal strength that can be detected by a photo detector being part of the laser sensor. The part of the laser light thrown back by the tire can be increased by one or more reflective structures, for example, integrated in the tread of the tire. Especially references for the depth of the tire tread can be provided by means of one or more reflective structures.

It is further an objective of the current invention to provide a simple and cost effective method of measuring tire parameters.

The objective is achieved by means of a method of measuring tire parameters comprising the steps of:
emitting laser light by means of a laser sensor;
detecting laser light thrown back by a tire by means of the laser sensor and
determining tire parameters by means of the laser sensor, using self-mixing interferometry of the emitted laser light and the reflected laser light.

Measuring methods based on self-mixing interferometry (SMI) make use of the effect that laser light, which is thrown back from the surface of the tire and reenters the laser cavity, interferes with the resonating radiation and thus influences the output properties of the laser. The laser light being thrown back comprises scattered, diffusely reflected and/or specularly reflected laser light. In the case of, for example, semiconductor lasers used in self-mixing laser sensors with a defined current shape, for example a periodic saw tooth or triangular current, the output frequency of the laser almost instantaneously follows those current variations due to the simultaneously changed optical resonator length. The resulting difference in frequency between the resonating and the back-scattered light can be evaluated in an analyzer and translated back to the desired position or velocity information. By collecting the laser output signal, which contains the information, via a photo detector comprised by the laser sensor, tire parameters can be determined. Surprisingly, it has been found that semiconductor-based SMI laser sensors using a vertical cavity surface-emitting laser (VCSEL) can be used for detecting the distance to or the movement of objects that are spaced apart more than some millimeters, despite the short cavity length. The short cavity length of the VCSEL was believed to determine the coherence length of the emitted laser beam, causing the restrictions in the detection range. The enhanced detection range enables the detection of the distance to the surface of the tire, which can be used for the determination of the tire parameters related to the surface structure of the tire. The surface structure for example can be the tread of a tire measured in a stationary testing device as depicted in FIG. 1 of EP 0547365 B1 or a system integrated in a vehicle like a car.

The method may comprise the additional step of focusing the emitted laser light or, alternatively, collimating the laser light into a parallel beam. Both focusing and collimating may be done by means of an optical device such as for example a lens. Focusing the laser light on the surface of the tire increases the resolution of the laser sensor, while a parallel beam of laser light needs no refocusing and may prevent problems related to a fixed focus distance, since auto-focussing to focus the surface of the tire independently of the distance may be possible, but seems to be rather elaborate and probably prone to error. The parallel beam may enable the simultaneous measurement of the two beat frequencies caused by the laser light thrown back at the bottom of the grooves and the upswings in between because of the enlarged spot diameter. Additionally, area-wide scanning of the surface of the tire may be possible by using an array of laser sensors, each having an enlarged spot diameter of for example 1 cm.

Additional features will be described below which can be combined together and combined with any of the aspects. Other advantages, especially over prior art, will be apparent to those skilled in the art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

The present invention will be explained in greater detail with reference to the figures, in which the same reference signs indicate similar parts, and in which:

FIG. 1 shows a schematic view of one embodiment according to the current invention.

FIG. 2 shows a schematic view of a laser sensor based on a Vertical Extended Cavity Surface Emitting Laser (VECSEL) that may be used in an embodiment according to the current invention.

FIG. 3 shows a schematic view of an array of laser sensors and a tire with reflective structures.

FIG. 4 shows a schematic view of a laser sensor being part of an embodiment according to the current invention, the laser sensor being integrated in a car.

FIG. 5 shows a further schematic view of a laser sensor being part of an embodiment according to the current invention, the laser sensor being integrated in a car.

### DETAILED DESCRIPTION OF EMBODIMENTS

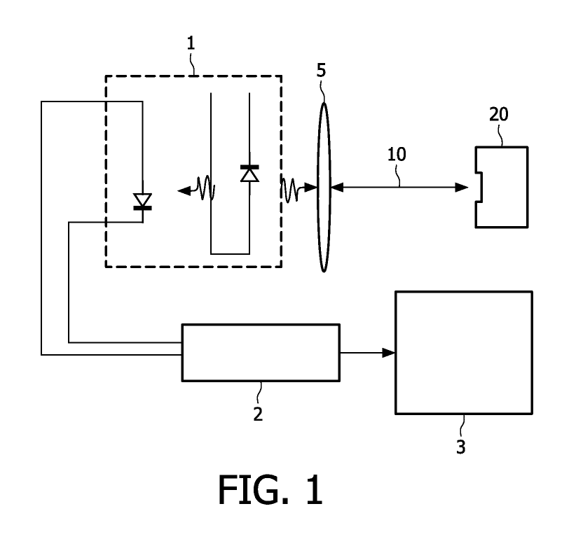

FIG. 1 shows a schematic view of an embodiment according to the current invention. The laser sensor 1 comprises a laser diode as a side emitter, a VCSEL or VECSEL and a photo detector. The laser diode emits laser light 10. A lens 5 is used to focus the laser light 10 on the surface of the tire or to collimate the laser light 10 in a parallel beam. The laser light 10 is thrown back by the surface or part of the surface of a tire 20. The thrown back laser light is focused on the laser cavity by means of the lens 5, re-enters the laser cavity and interferes with the resonating light in the laser cavity, resulting in variations of the resonating light, which are detected by means of the photo detector. The detected variations of the resonating light in the laser cavity are converted to electrical signals by means of the photo detector, analyzed by the analyzer 2 in the form of a processor and finally indicated by an indicator 3 in the form of a screen in a car informing a driver about the tread wear of the tire 20.

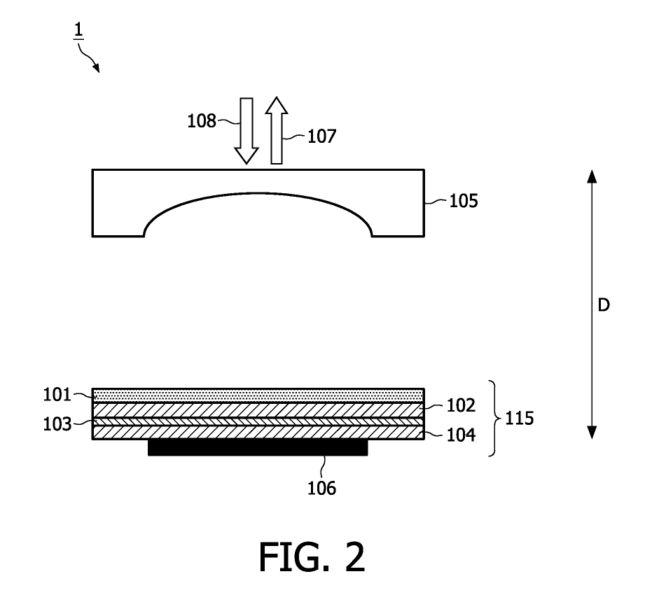

The laser sensor 1 depicted in FIG. 2 is a VECSEL consisting of a VCSEL layer structure 115 formed by an electrically pumped gain medium 103 (InGaAs quantum wells embedded in GaAs) embedded between two Distributed Bragg Reflectors (DBR) 102, 104, which form an inner cavity of the laser. The lower DBR 104 is highly reflective (reflectivity preferably >99.5%) for the lasing wavelength, while the reflectivity of the upper DBR 102 is smaller in order to allow feedback from the external cavity (In a VCSEL the reflectivity of the upper DBR 102 is higher in order to enable lasing without feedback from an external cavity). One of the DBRs is p-doped and the other n-doped to enable efficient current feeding into the gain region. In this example, the lower DBR 104 with higher reflectivity is p-doped and the upper DBR 102 is n-doped. Nevertheless, also doping in the reverse order is principally possible.

The operating current for current injection into the gain medium 103 is provided by an appropriate power source (not shown) which, in the embodiment of the proposed laser sensor of FIG. 2, is connected to a sensor control unit (not shown) or includes such a control unit for timely modulating the injection current. With this current modulation a frequency shift of the emitted laser radiation 107 for obtaining the desired distance or velocity information is achieved. The variation of injected charge carriers results in a variation of the refractive index of the gain medium 103 and thus also in a variation of the optical cavity length D. The center wavelength λ_{c} of a longitudinal cavity mode is given by

$${λ}_{c} = \frac{2 \cdot D}{m} ,$$

where m is the order of the respective mode. An increase in the optical cavity length thus also increases the emission wavelength of a given longitudinal mode. Typical wavelength shifts of about Δλ_{c}≈0.5 nm can be realized. This range can be considerably extended if necessary by introducing other measures such as for example moveable laser mirror 105.

Via the n- and p-DBR electrical contacts (not shown in the figure), a suited current shape is fed into the gain region of the embodiment of FIG. 2. A photo detector 106 which is attached to the back side of the lower DBR 104 measures the small amount of radiation leaking out of the highly reflective p-DBR mirror 104 and thus monitors the influence of the backscattered light 108 from the target object (not shown in the figures) on the laser, from which information on the distance or the velocity of the target object can be extracted. The VCSEL layer structure 115 is grown on an appropriate optically transparent substrate 101. Such a layer structure on this substrate can be produced in a low-cost production process for VCSEL chips. The photo detector 106 therefore is attached to the back side of such a chip.

The external cavity is formed by the laser mirror 105 placed and adjusted above the upper DBR 102 at a suited distance as shown in FIG. 2. A metal can be used to form this laser mirror 105, for example, or a dielectric-coated mirror or a narrow band Volume Bragg Grating (VBG) with suited IR reflection properties may be used as the laser mirror 115. The gain medium is electrically pumped to a level which does not allow the inner cavity system to exceed the laser threshold, but which requires the feedback from the external cavity, i.e. the external laser mirror 105, to achieve lasing. In this way the properties of the emitted laser radiation 107 are determined by the external cavity rather than by the short inner cavity on the VCSEL chip. Consequently, also the divergence angle of the emitted laser radiation 107 is decreased and the mode quality is enhanced compared to a pure VCSEL-based sensor. Thus, the laser can be better focused on a target object, and the feedback 108 (backscattered radiation from the target object) into the laser cavity, which is required for the sensing application, is improved. This results in an improved performance of the system shown for example in FIG. 1.

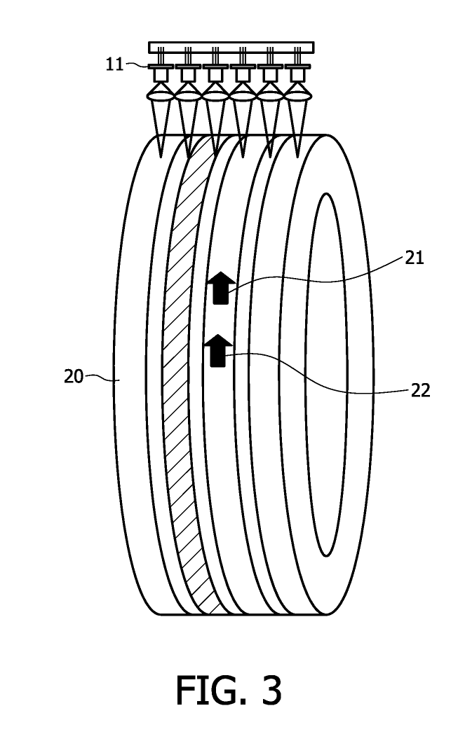

The array 11 of laser sensors shown in FIG. 3 enables the simultaneous detection of tire parameters of nearly the whole tread of the tire 20. The laser sensors comprise lenses focusing the laser light in small spots on the surface of the tire 20. Reflective structures such as the arrows 21 and 22 integrated in the tread of the tire 20 are used to increase the amount of laser light thrown back to the laser cavity in order to improve the signal to noise ratio.

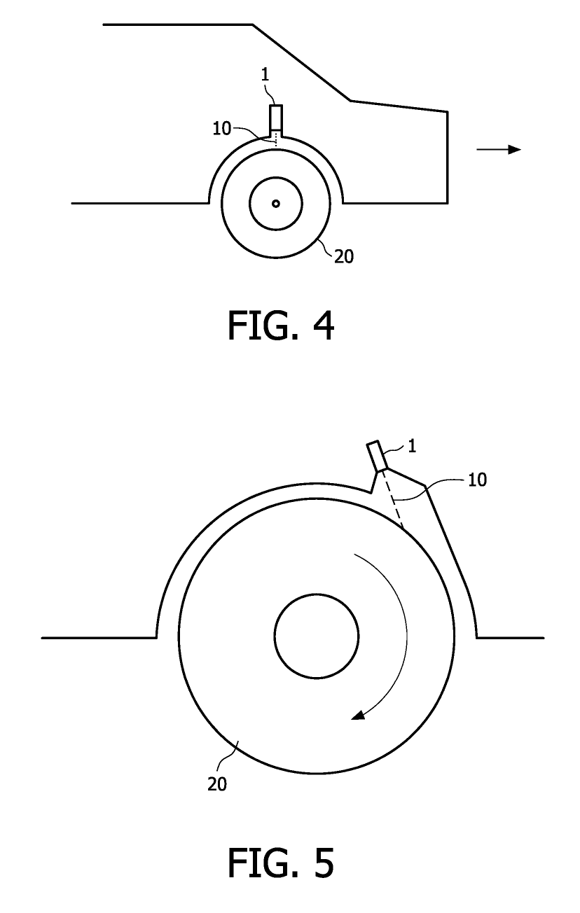

In FIG. 4 a system according to the current invention is integrated in a car. The laser sensor 1 is integrated in the chassis of the car preferably in such a way that dirt-soiling of the laser sensor during driving (forward direction of driving indicated by the arrow) is minimized. The laser light 10 emitted by the laser sensor hits the surface of the tire 20 perpendicularly to the plane of the surface of the tire, that means the laser light is directed to the center of the tire. This arrangement is used to detect the distance to the surface element of the tire 20, enabling tire tread wear detection, tire load detection and/or detection of oscillations of the chassis with respect to the tire 20. Speed detection is not possible since there is no vector component of the speed of rotation of the surface elements of the tire 20 being collinear with the direction of the emitted laser light 10. FIG. 5 shows an enlarged view of a wheel case wherein a laser sensor 1 is integrated. Laser light 10 hits the surface elements of the tire 20 in such a way that there is a vector component of the rotational speed of the surface elements of the tire 20 being collinear with the direction of the emitted laser light 10. This collinear vector component of the rotational speed of the surface elements of the tire 20 enables the detection of the speed of the car by means of Doppler shift of the laser light thrown back to the laser sensor 1. The same configuration may be used for tire tread wear detection, tire load detection and/or detection of oscillations of the chassis with respect to the tire 20 by using different driving schemes and/or detection schemes of the laser sensor 1. Due to the fact that the tire tread wear, the load of the tire and oscillations may influence for example the detection of the speed of the car, the results from one measurement may be used to correct the measurement of the other measurement. One example might be: the load of a tire determines the target area on the surface of the tire 20 where the laser light 10 hits the surface of the tire 20, influencing the vector component of the rotational speed of the surface elements of the tire 20 being collinear with the direction of the emitted laser light 10. Depending on the detected tire load, the measurement of the speed may be corrected by means of the analyzer. Alternatively, two laser sensors 1 may be used, one detecting the load and the other one detecting the rotational speed of the tire 20 (for example a combination of the embodiments shown in FIG. 4 and FIG. 5). The results of the measurements are processed by the analyzer 2, the interdependence of the results of the different measurements being taken into account by means of a (mathematical) model implemented in the analyzer.

The laser sensor 1 is arranged in a cavity preventing or at least limiting dirt-soiling of the laser sensor 1 during forward driving indicated by the arrow. In addition, means for protecting the laser sensor 1 during reverse driving, such as a cover that can be closed, can be added. Additionally, means for cleaning the laser sensor, such as a nozzle for ejecting water, can be added. Further, it is possible to indicate that the laser sensor has to be cleaned. This can be done by means of the system according to the invention by detecting, analyzing and indicating the light thrown back by dirt.

The present invention has been described with respect to particular embodiments and with reference to certain drawings, but this is not to be construed in a limiting sense, as the invention is limited only by the appended claims. Any reference signs in the claims shall not be construed as limiting the scope thereof. The drawings described are only schematic and are non-limiting. In the drawings, the size of some of the elements may be exaggerated and not drawn to scale for illustrative purposes. Where the term “comprising” is used in the present description and claims, it does not exclude other elements or steps. Where an indefinite or definite article is used when referring to a singular noun, e.g. “a” or “an”, “the”, this includes a plural of that noun unless specifically stated otherwise.

Furthermore, the terms first, second, third and the like in the description and in the claims are used for distinguishing between similar elements and not necessarily for describing a sequential or chronological order. It is to be understood that the terms so used are interchangeable under appropriate circumstances, and that the embodiments of the invention described herein are capable of operation in other sequences than described or illustrated herein.

Moreover, the terms top, bottom, first, second and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Other variations of the disclosed embodiments can be understood and effected by those skilled in the art in practicing the claimed invention, from a study of the drawings, the disclosure, and the appended claims.

1. System for measuring tire parameters, comprising at least one laser sensor, an analyzer and an indicator, the laser sensor being arranged outside a tire and designed to emit laser light such that the laser light impinges on a tread of the tire from outside of the tire and the laser sensor detects the laser light reflected the tread of the tire by means of self-mixing laser interferometry, the analyzer is designed to process sensor data provided by the laser sensor and the indicator is designed to indicate the status of the tire.

2. System according to claim 1, the laser sensor comprising a vertical cavity surface-emitting laser.

3. System according to claim 1 being integrated in a vehicle.

4. System according to claim 1, the system further comprising a storing device for storing reference data, the analyzer being designed to compare the sensor data provided by the self-mixing laser sensor with the reference data and the indicator being designed to indicate the result of the comparison between the reference data and the sensor data.

5. System according to claim 3, the system comprising at least one laser sensor per tire (20) of the vehicle.

6. System according to claim 3, the system comprising a plurality of laser sensors for measuring tire parameters of one tire of the vehicle.

7. System according to claim 5, the analyzer being further designed to compare the sensor data of the different tires of the vehicle, and the indicator is further designed to indicate the result of the comparison of the sensor data of the different tires of the vehicle.

8-10. (canceled)
